(19) United States
(12) Patent Application Publication
(10) Pub. No.: US 2025/0233756 A1
(43) Pub. Date: Jul. 17, 2025

(54) Computer-readable Media, Methods, Apparatuses and Computer Programs for an Attester and a Verifier

(71) Applicant: Intel Corporation, Santa Clara, CA (US)

(72) Inventors: Ned M. SMITH, Beaverton, OR (US); Ram KRISHNAN, Cupertino, CA (US)

(21) Appl. No.: 19/096,925

(22) Filed: Apr. 1, 2025

(51) Int. Cl. H04L 9/32

(52) U.S. Cl. CPC H04L 9/3247

(57) ABSTRACT

The present disclosure relates to a computer-readable medium, a method, an apparatus, and a computer program for an attester computer system, to a attester computer system comprising such an apparatus, to a computer-readable medium, a methods, an apparatus, and a computer program for a verifier computer system, to a verifier computer system comprising such an apparatus, and to a system comprising an attester computer system and a verifier computer system or two combined attester and verifier computer systems. For example, the present disclosure relates to a non-transitory computer-readable medium storing instructions that, when executed by one or more processing circuitries, cause the one or more processing circuitries to perform a method for an attester computer system, comprising collecting, during a boot process of the attester computer system, boot-time attestation evidence of the attester computer system, obtaining, during the boot process, a value being indicative of the boot process, with the value changing across boot processes, digitally signing, using an attestation key, at least one data structure comprising the boot-time attestation evidence and the value being indicative of the boot process, and providing the at least one signed data structure to a verifier computer system.

### BACKGROUND

One mechanism for determining, by one computer system, whether to trust another computer system is based on the verification of evidence that is provided by the other computer system. This evidence is used to attempt to attest the trustworthiness of the other computer system.

A challenge facing attestation verifiers is ensuring attestation that evidence is fresh. Evidence is considered fresh immediately after evidence is collected. However, evidence collected during bootstrap remains fresh until the next boot as bootstrap components are transitory. An attack on a bootstrap component will not take effect until the next boot cycle.

Attestation verifiers may receive bootstrap evidence that cannot be distinguished from evidence of multiple previous bootstrap events. An attacker may replay evidence from one of these previous events to mask an attack on the current bootstrap component.

Other approaches only consider the currently booted system. For example, TPM (Trusted Platform Module) PCRs (which are reset on power reset) and secure boot techniques can mitigate many attacks on bootstrap components. However, secure boot techniques do not ensure evidence freshness, they only reduce the likelihood of evidence becoming stale due to successful attacks.

### BRIEF DESCRIPTION OF THE FIGURES

Some examples of apparatuses and/or methods will be described in the following by way of example only, and with reference to the accompanying figures, in which

FIG. 1a shows a flow chart of an example of a method for an attester computer system;

FIG. 1b shows a schematic diagram of an example of an apparatus or device for an attester computer system, and of an attester computer system comprising such an apparatus or device;

FIG. 2a shows a flow chart of an example of a method for a verifier computer system;

FIG. 2b shows a schematic diagram of an example of an apparatus or device for a verifier computer system, and of a verifier computer system comprising such an apparatus or device;

FIG. 3 shows a schematic diagram of an example of a distributed workload implementing a workflow involving multiple nodes;

FIG. 4 shows a schematic diagram of an example of a confidential compute environment;

FIG. 5 shows an illustration of workflow nodes as attester and verifier with nonce exchange involving boot-time inclusion of nonce; and

FIG. 6 shows an attester constructing evidence involving runtime and boot-time nonces supplied by a verifier.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

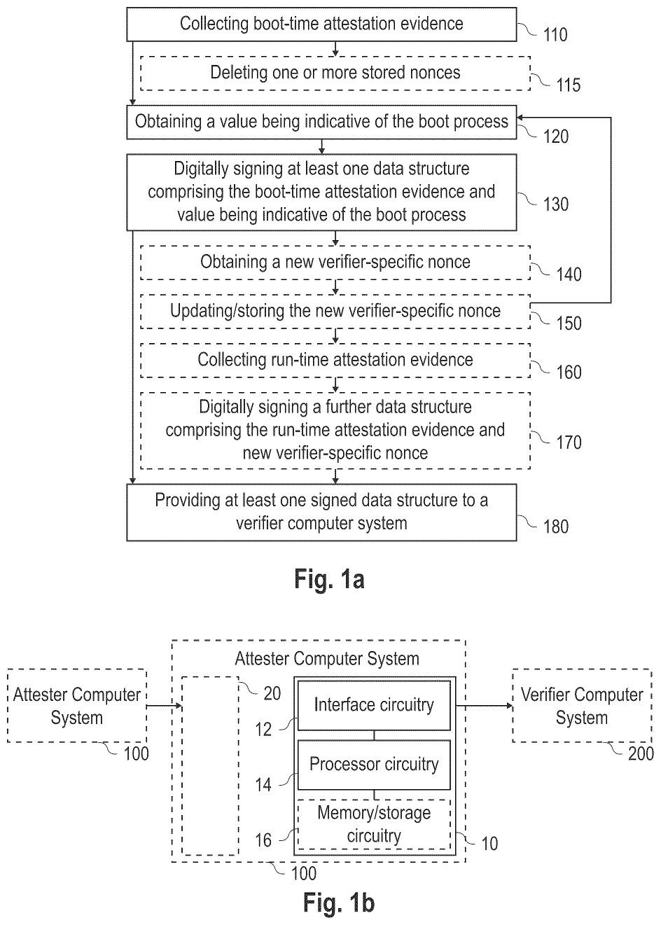

FIG. 1a shows a flow chart of an example of a method for an attester computer system 100 (shown in FIG. 1b). The method comprises collecting 110, during a boot process of the attester computer system, boot-time attestation evidence of the attester computer system. The method comprises obtaining 120, during the boot process, a value being indicative of the boot process. The value changes across boot processes. The method comprises digitally signing 130, using an attestation key, at least one data structure comprising the boot-time attestation evidence and the value being indicative of the boot process. The method comprises providing 180 the at least one signed data structure to a verifier computer system. For example, the method may be performed by the attester computer system 100, e.g., by an apparatus 10 or device 10 for the attester computer system 100.

FIG. 1b shows a schematic diagram of an example of the apparatus 10 or device 10 for the attester computer system 100, and of the attester computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1b comprises interface circuitry 12, processor circuitry 14, and (optional) memory/storage circuitry 16. For example, the processor circuitry 14 may be coupled with the interface circuitry 12 and/or with the memory/storage circuitry 16. For example, the processor circuitry 14 may provide the functionality of the apparatus, in conjunction with the interface circuitry 12 (for communicating with other entities inside or outside the computer system 100, e.g., with verifier computer system 200), and the memory/storage circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1b comprises means for processing 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory or storage circuitry 16 or means for storing information 16.

In general, the apparatus 10 or device 10 may be configured to execute the method of FIG. 1a. For example, the apparatus 10 or device 10 (e.g., the processor circuitry 14 or means for processing 14) collects, during a boot process of the attester computer system, boot-time attestation evidence of the attester computer system. For example, the apparatus 10 or device 10 (e.g., the processor circuitry 14 or means for processing 14) obtains, during the boot process, a value being indicative of the boot process, with the value changing across boot processes. For example, the apparatus 10 or device 10 (e.g., the processor circuitry 14 or means for processing 14) digitally signs, using an attestation key, at least one data structure comprising the boot-time attestation evidence and the value being indicative of the boot process. For example, the apparatus 10 or device 10 (e.g., the processor circuitry 14 or means for processing 14) provides the at least one signed data structure to a verifier computer system.

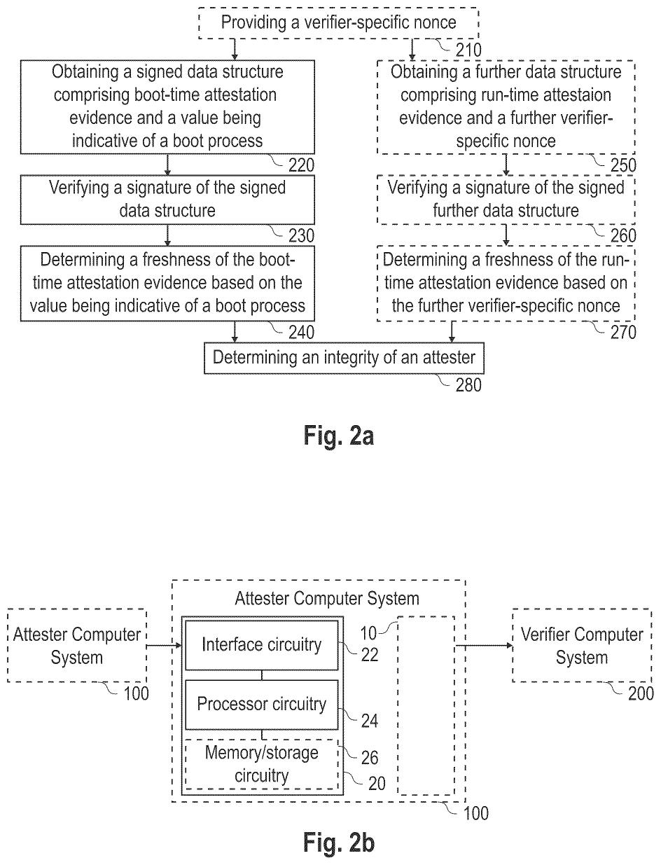

Optionally, the attester computer system may further comprise an apparatus 20 or device 20, as discussed in connection with FIGS. 2a and 2b.

In the following, the features of the method of FIG. 1a as well as the apparatus 10 or device 10 and attester computer system 100 are discussed in connection with the method of FIG. 1a. Features introduced in connection with the method of FIG. 1a may likewise be included in the corresponding apparatus 10, device 10 and attester computer system 100.

The proposed concept relates to the interaction between attester (i.e., the entity collecting evidence/measurements that are to be verified to prove the trustworthiness of the attester) and verifier. In an attestation or verification process between two computer systems, one system (the attester, sometimes also called prover) provides evidence of its state or configuration to another system (the verifier). This is typically done using cryptographic techniques. The prover generates a report or proof, often signed with a cryptographic key, that attests to certain properties such as software versions or security configurations. The verifier can then check the authenticity and integrity of this evidence by validating the cryptographic signature and ensuring it meets the expected criteria. This process helps ensure trust and security between the two systems.

One challenge in attestation relates to the freshness of the evidence provided by the attester. If, between collecting the evidence and providing the evidence to the verifier, time has passed, manipulations may have occurred at the attester, and the evidence might not truly represent the state of the attester. For the evidence collected during run-time, the verifier can request the attester to collect new evidence that meets some freshness criterion. For boot-time evidence, this is often not feasible, as it would require a reboot of the attester to provide boot-time attestation evidence that has just been collected. To mitigate this challenge, in the present context, the signed boot-time evidence is provided together with a value that is indicative of the boot process (that changes across boot processes). In other words, a value is specifically included that changes over time, e.g., every time the attester computer system reboots. Thus, the value being indicative of the boot process may indicate during which boot process the boot-time evidence has been collected. Due to the value changing across boot processes (e.g., every time the attester computer system reboots, or every time the attester computer system establishes a secure channel with the verifier computer system), the value being indicative of the boot process indicates the freshness of the boot-time attestation evidence. The integrity of the process can be ensured, during boot-time, by a hardware RoT and/or firmware of the attester computer system. In other words, the acts of obtaining the value that is indicative of the boot process and digitally signing the at least one data structure may be performed by a firmware or root of trust of the attester computer system.

There are various options for implementing such a value being indicative of the boot process. For example, the value being indicative of the boot process may specify the boot time, i.e., at which time the attester computer system has booted, or at which time the evidence has been collected, or at which time the data structure has been signed. Accordingly, the value being indicative of the boot process may comprise a value being indicative of a boot time. For example, the value being indicative of a boot time may express the boot time relative to an epoch. For example, that epoch may be defined between the attester computer system and the verifier computer system. Additionally, or alternatively, the value being indicative of the boot process may comprise a number that increases monotonically across boot processes (e.g., a value that increases by a pre-defined number every time the attester computer system reboots, e.g., a boot counter).

In various examples of the present disclosure, the value being indicative of the boot process is defined by the verifier computer system. In other words, the verifier computer system may provide a value (in the following called “nonce”) to the attester computer system, which may include this value into the data structure of subsequent submissions. In other words, the value being indicative of the boot process may comprise a verifier-specific nonce (being provided by the verifier). As the nonce is verifier-specific, the method of FIG. 1a may comprise storing 150 a plurality of verifier-specific nonces for a plurality of different verifier computer systems.

For example, the nonce may be a random value (with the verifier(s) keeping track of which nonces have been used and placing them on a do-not-reuse list), or a semi-random value that is bound to increase monotonically. For example, the method may comprise obtaining the nonce (at boot-time) from secure persistent storage (e.g., of a trusted execution environment). Moreover, before it can be used, the nonce is received from the verifier computer system and stored in the secure persistent storage. Moreover, as further shown in FIG. 1a, the method may comprise obtaining 140, upon establishment of a secure communication channel between the attester computer system and the verifier computer system, a new verifier-specific nonce, and storing or updating 150 (depending on whether a nonce for the verifier is already stored in the secure persistent storage) the verifier-specific nonce in the secure persistent storage.

The verifier might not only be used for indicating the freshness of the boot-time attestation evidence, but also (e.g., for the same purpose) for run-time attestation evidence. Accordingly, the method may comprise collecting 160, after obtaining the new verifier-specific nonce, run-time attestation evidence of the attester computer system, digitally signing 170 a further data structure comprising the run-time attestation evidence and the new verifier-specific nonce and providing 180 the signed further data structure together with the at least one signed data structure to the verifier computer system. Thus, the proposed mechanism also applies equally to components of the system that are available during normal operation (post boot) such as, in case of Intel® TDX, Intel TDX Quoting TD (QTD) and Intel SGX Quoting Enclave (QE). For example, an Attester may present a freshness nonce to a Quoting TD that responds by collecting measurements of a tenant TD (dynamically—in response to receiving the nonce) which is then included in the Evidence that was collected of the tenant TD. It is noted that there are two possible ways a Quoting TD/Enclave may be triggered to collect measurements. (A) in response to the tenant TD request made to the QTD/QE; in this case the tenant may present the nonce on behalf of the Verifier. (B) The QTD/QE has an outside connection to the Verifier and receives the nonce directly. Then independent of the tenant, collects the evidence and includes the nonce in the evidence before signing it.

When including the nonce with both boot-time evidence and run-time evidence, there is likely to be a disconnect between the nonces being used for the two data structures, as the run-time evidence is provided together with the newly received nonce and the boot-time evidence is provided together with the nonce that was stored in persistent storage during boot time. In other words, the at least one signed data structure may comprise a verifier-specific nonce that was stored in secure persistent storage prior to updating the verifier-specific nonce in the secure persistent storage and the signed further data structure may comprise the new verifier-specific nonce.

In some examples, nonces might not only be different across verifiers, but also across different components of the attester computer system (including bootstrapped and runtime updatable components). In other words, the nonce may be a verifier-specific and attester component-specific nonce. For example, the components of the attester may be assigned different nonces, e.g., each component may have a different nonce (depending on its availability and updatability properties).

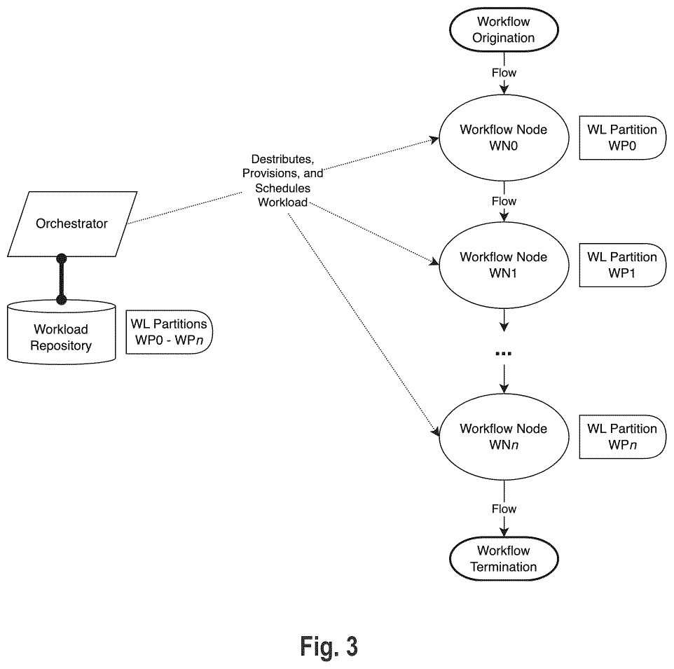

Moreover, nonces differ across verifiers. For example, the attester may be a node that performs a subset of processing work in a workflow of nodes (see FIG. 3). In other words, the at least one signed data structure may be provided to a verifier computer system that follows the attester computer system in a sequence defined by a workflow. Within a workflow of nodes, subsequent nodes may present nonces (as verifiers) to previous nodes (which may in turn be presented to the various components of the node) such that a final node in a workflow can surmise the freshness for all nodes that participated in the workload and resolve freshness to all components of the systems that operated on some aspect of the workload.

In some cases, there may be manipulations or other changes of the boot environment that lead to a change to the boot-time evidence. In these cases, the verifier-specific nonce(s) may be deleted, to signal to the respective verifiers that there have been changes in the boot environment. In other words, as shown in FIG. 1a, the method may comprise, if the collected boot-time evidence differs from prior collected (e.g., previously collected) boot-time evidence, deleting 115 one or more stored nonces, and signing the at least one data structure without including a nonce in the data structure.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a Field-Programmable Gate Array (FPGA), such as a FPGA implementing processor or (micro-)controller logic, a micro-controller, etc. For example, on an FPGA, a microcontroller design can be programmed and isolated from tenant designs that then can use the microcontroller as if the microcontroller was a discrete microcontroller. In this case, the FPGA-based microcontroller may comprise the processor circuitry or means for processing 14, the interface circuitry or means for communicating 12, and/or the memory or storage circuitry/means for storing information 16.

For example, the memory or storage circuitry 16 or means for storing information 16 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), such as static Random Access Memory of an FPGA, block Random Access Memory of an FPGA, distributed Random Access Memory of an FPGA, Programmable Read Only Memory (PROM), Erasable Programmable Read Only Memory (EPROM), an Electronically Erasable Programmable Read Only Memory (EEPROM), or a network storage.

More details and aspects of the method, apparatus, and device for the attester computer system and of the attester computer system are mentioned in connection with the proposed concept or one or more examples described above or below (e.g. FIGS. 2a to 6). The method, apparatus, and device for the attester computer system and the attester computer system may comprise one or more additional optional features corresponding to one or more aspects of the proposed concept or one or more examples described above or below.

FIG. 2a shows a flow chart of an example of a method for a verifier computer system 200 (shown in FIG. 2b). The method comprises obtaining 220, from an attester computer system 100 (e.g., as discussed in connection with FIGS. 1a and 1b), a signed data structure comprising boot-time attestation evidence and a value being indicative of a boot process. The method comprises verifying 230 a signature of the data structure and the boot-time attestation evidence. The method comprises determining 240 a freshness of the boot-time attestation evidence based on the value being indicative of the boot process. The method comprises determining 280 an integrity of the attester based on the verification of the signature of the data structure and the boot-time attestation evidence and based on the freshness of the boot-time attestation evidence. For example, the method may be performed by the verifier computer system.

FIG. 2b shows a schematic diagram of an example of an apparatus 20 or device 20 for the verifier computer system 200 and of the verifier computer system 200 comprising such an apparatus 20 or device 20. The apparatus 20 comprises circuitry to provide the functionality of the apparatus 20. For example, the circuitry of the apparatus 20 may be configured to provide the functionality of the apparatus 20. For example, the apparatus 20 of FIG. 2b comprises interface circuitry 22, processor circuitry 24, and (optional) memory/storage circuitry 26. For example, the processor circuitry 24 may be coupled with the interface circuitry 22 and/or with the memory/storage circuitry 26. For example, the processor circuitry 24 may provide the functionality of the apparatus, in conjunction with the interface circuitry 22 (for communicating with other entities inside or outside the computer system 200, e.g., with attester computer system 100), and the memory/storage circuitry 26 (for storing information, such as machine-readable instructions). Likewise, the device 20 may comprise means for providing the functionality of the device 20. For example, the means may be configured to provide the functionality of the device 20. The components of the device 20 are defined as component means, which may correspond to, or implemented by, the respective structural components of the apparatus 20. For example, the device 20 of FIG. 2b comprises means for processing 24, which may correspond to or be implemented by the processor circuitry 24, means for communicating 22, which may correspond to or be implemented by the interface circuitry 22, (optional) means for storing information 26, which may correspond to or be implemented by the memory or storage circuitry 26. In general, the functionality of the processor circuitry 24 or means for processing 24 may be implemented by the processor circuitry 24 or means for processing 24 executing machine-readable instructions. Accordingly, any feature ascribed to the processor circuitry 24 or means for processing 24 may be defined by one or more instructions of a plurality of machine-readable instructions. The apparatus 20 or device 20 may comprise the machine-readable instructions, e.g., within the memory or storage circuitry 26 or means for storing information 26.

In general, the apparatus 20 or device 20 may be configured to execute the method of FIG. 2a. For example, the apparatus 20 or device 20 (e.g., the processor circuitry 24 or means for processing 24) obtains, from an attester computer system 100 (e.g., as discussed in connection with FIGS. 1a and 1b), a signed data structure comprising boot-time attestation evidence and a value being indicative of a boot process. For example, the apparatus 20 or device 20 (e.g., the processor circuitry 24 or means for processing 24) verifies a signature of the data structure and the boot-time attestation evidence. For example, the apparatus 20 or device 20 (e.g., the processor circuitry 24 or means for processing 24) determines a freshness of the boot-time attestation evidence based on the value being indicative of the boot process.

For example, the apparatus 20 or device 20 (e.g., the processor circuitry 24 or means for processing 24) determines an integrity of the attester based on the verification of the signature of the data structure and the boot-time attestation evidence and based on the freshness of the boot-time attestation evidence. For example, the method may be performed by the verifier computer system 200.

Optionally, the verifier computer system 200 may further comprise an apparatus 20 or device 20, as discussed in connection with FIGS. 2a and 2b.

In the following, the features of the method of FIG. 2a as well as the apparatus 20 or device 20 and verifier computer system 200 are discussed in connection with the method of FIG. 2a. Features introduced in connection with the method of FIG. 2a may likewise be included in the corresponding apparatus 20, device 20, and verifier computer system 200.

As discussed in connection with FIGS. 1a and 1b, the attester computer system 100 provides its boot-time attestation evidence (and, optionally, its run-time attestation evidence) together with a value being indicative of the boot process to the verifier computer system. The verifier computer system uses that value to determine the “freshness” of the boot-time (or run-time) attestation evidence. In this connection, the freshness of the (boot-time or run-time) attestation evidence relates to a time span (or number of boot processes) having occurred between collection and transmission of the respective evidence. In other words, the freshness of the respective evidence indicates whether the respective evidence is fresh (i.e., has been collected at a most recent time, e.g., the last process or after provision of a new verifier-specific nonce) or stale (i.e., has been collected at a prior time, e.g., not during the most recent boot process or not after the verifier computer system has provided a new verifier-specific nonce). Depending on which type of value being indicative of the boot process is used, the process for determining the freshness of the respective evidence may differ.

For example, if the value being indicative of the boot process comprises a value being indicative of a boot time, determining the freshness of the boot-time attestation evidence may comprise comparing the boot time to a current time or to a reference time (e.g., a reference time calculated based on the current time). If the boot time is too long ago, the boot-time attestation evidence may be considered stale. If the value being indicative of the boot process comprises a number that increases monotonically across boot processes, determining the freshness of the boot-time attestation evidence comprises comparing the number that increases monotonically across boot processes to one or more previously obtained numbers associated with the attester computer system. If the number is lower than previously obtained numbers, or if the number has not changed for some time, the boot-time attestation evidence may be considered stale.

In various examples, a verifier-specific nonce is used to determine the freshness of the boot-time (and run-time attestation evidence). In other words, the value being indicative of the boot process may comprise a verifier-specific nonce. This nonce may be provided by the verifier computer system to the attester computer system. The verifier computer system may generate the nonce, store the generated nonce(s) in a (secure persistent) storage of the verifier computer system, and provide the nonce to the attester computer system. For example, different nonces may be provided to different attester computer systems, and/or different nonces may be provided for different components of an attester computer system. Thus, as further shown in FIG. 1b, the method may comprise providing 210, prior to obtaining the signed data structure from the attester computer system, the verifier-specific nonce to the attester computer system. For example, a new nonce may be provided (every time) after a secure channel is established between the verifier computer system and the attester computer system. In other words, the verifier-specific nonce may be provided to the attester computer system upon establishment of a secure communication channel between the verifier computer system and the attester computer system.

To determine the freshness of the boot-time (and run-time) attestation evidence, the verifier may compare the nonce(s) included in the received data structures to the nonce(s) provided to the attester computer system. In other words, determining the freshness of the boot-time attestation evidence may comprise comparing the verifier-specific nonce to one or more verifier-specific nonces that have previously been provided to the attester computer system.

As outlined in connection with FIGS. 1a and 1b, the freshness might not only be determined for the boot-time attestation evidence, but also for the run-time attestation evidence. Accordingly, as further shown in FIG. 1b, the method may comprise obtaining 250 a further data structure comprising run-time attestation evidence and a further verifier-specific nonce from the attester computer system and comparing the further verifier-specific nonce to a most recent verifier-specific nonce that has previously been provided to the attester computer system to determine 260 the freshness of the run-time attestation evidence.

As shown in FIG. 3, the verifier computer system 200 (which may also be an attester computer system) may be a node in a chain of nodes performing a workflow. Accordingly, the present disclosure also relates to a system comprising the verifier computer system 200 and the attester computer system 100. Accordingly, the at least one signed data structure may be obtained from an attester computer system that precedes the verifier computer system in a sequence defined by a workflow. For example, all nodes of the workflow (except the first and last node) may be attester and verifier at the same time, i.e., attester with respect to the subsequent node, verifier with respect to the preceding node. Accordingly, the present disclosure also relates to a system comprising two or more attester and verifier computer systems.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processor circuitry 24 or means for processing 24 may be implemented using one or more processing units, one or more processing devices, any means for processing, such as a processor, a computer or a programmable hardware component being operable with accordingly adapted software. In other words, the described function of the processor circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory or storage circuitry 26 or means for storing information 26 may a volatile memory, e.g., random access memory, such as dynamic random-access memory (DRAM), and/or comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the method, apparatus, and device for the verifier computer system and of the verifier computer system are mentioned in connection with the proposed concept or one or more examples described above or below (e.g., FIGS. 1a to 1b, 3 to 6). The method, apparatus, and device for the verifier computer system and the verifier computer system may comprise one or more additional optional features corresponding to one or more aspects of the proposed concept or one or more examples described above or below.

Various examples of the present disclosure relate to a scalable distributed verifier with bootstrap nonce.

Distributed workloads using confidential computing environments (CCE) (e.g., Intel Trust Domain Extensions (TDX) Trust Domains (TDs)) may distribute an attestation verifier capability among peer workload nodes. This avoids single point of failure/single point of attack weaknesses. A challenge facing attestation verifiers is ensuring attestation evidence is fresh.

Various examples of the present disclosure use secure storage in attestation verifiers to persist nonce values for workload peers that may undergo a reboot during the lifetime of the workload. The verifier (verifier computer system 200) may proactively present a (verifier-specific) nonce to the peer (Attester computer system) for use during its next boot cycle. The attester may save the nonce in local secure memory (which is not reset when power is reset).

When the attester boots, evidence collection may include the persisted nonce. When evidence is presented to the verifier, including the nonce, the verifier may compare its archived original with the nonce included in evidence. If they are the same, the verifier may be assured the attester's evidence is fresh from the most recent boot event.

Central verifiers may interact with hundreds of thousands or even millions of attesters and may archive a nonce for each attester in secure memory. Central verifiers might not know when to release the archived nonce since they may not be able to predict when or even if the attester will return to the verifier (with the original nonce).

The proposed concept relies on the workload context to know when to flush outstanding nonces and to know which nodes participate in the workload, thereby knowing how much secure storage resource is needed to support the distributed nodes. An overarching benefit may be that all nodes in the workflow can proactively assess that all other nodes in the workflow have supplied fresh evidence, even when a node reboots.

Workflow nodes, as attestation verifiers, may have persistent secure memory for proactive storage of an evidence freshness nonce for each peer node participating in the workload. Moreover, workflow nodes, as attesters, may have persistent secure memory for storing an evidence freshness nonce that survives power reset events. In the proposed concept, the freshness nonce may be included in evidence as part of attestation evidence collection/signing. The task of proactively providing a freshness nonce may be used in an attestation conveyance protocol. The proactive evidence freshness nonce may be used to better ensure freshness of measured bootstrap (transient) components that originate from a verifier and is presented back to the verifier after a subsequent boot event.

An overview of the invention architecture is shown in FIG. 1, where a distributed workload orchestrator prepares a workload obtained from a workload repository for distribution and deployment to a collection of edge, cloud, enterprise, IoT (Internet of Things), or rack-scale network. FIG. 3 shows a schematic diagram of an example of a distributed workload implementing a workflow involving multiple nodes. The orchestrator creates workflow nodes WN0-WNn; provisions them with a workload that has been compiled to be partitioned for execution on multiple nodes (i.e., WP0-WPn); schedules the workload for execution by signaling the first workflow node (WP0) to begin the workflow. The workflow transitions to the next workflow node (WN1) which executes (WP1) until the final workflow node (WNn) executes the partitioned workload (WPn). Upon termination of the workflow, the terminating node signals the orchestrator that the workload is complete. The orchestrator de-provisions the workload nodes which may involve removing provisioned workload images, removing workflow-specific cryptographic keys, and removing other security state.

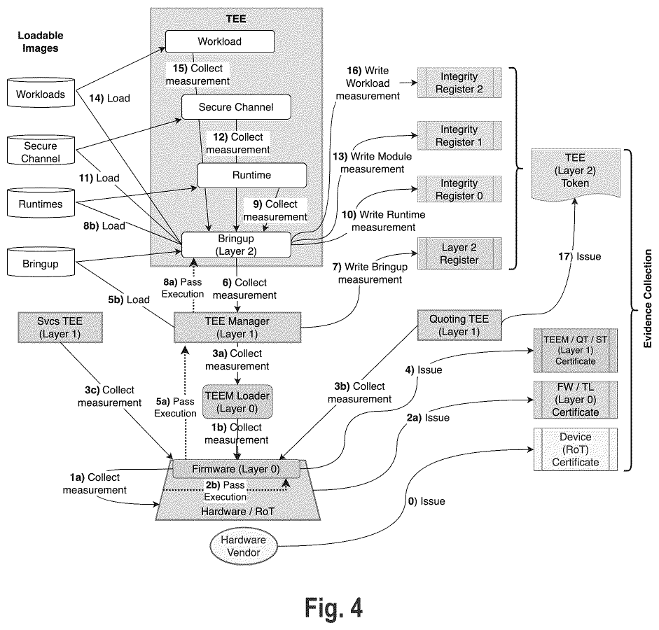

FIG. 4 shows a schematic diagram of an example of a confidential compute environment, commonly referred to as a Trusted Execution Environment (TEE). FIG. 4 illustrates a trusted bootstrap sequence that depends on hardware root-of-trust components such as Trusted Platform Module (TPM), Direct Internet Connection Establishment (DICE), and Device Partitioning Engine (DPE), or similar root-of-trust technologies (RoT). The sequence results in the creation of (boot-time) attestation evidence, which is then provided to an attestation verifier for verification. FIG. 4 shows a workflow node with measured boot layers.

In the following, a detailed breakdown of example bootstrap sequence operations is discussed with reference to FIG. 4. In operation 0, the hardware (HW) vendor provides a Device Root-of-Trust (RoT) credential and integrates the device key into the hardware-based RoT module. In operation 1a, the Hardware Root-of-Trust (RoT) gathers measurements (i.e., evidence) of firmware components, for example the CPU (Central Processing Unit) complex, S3M, MCHECK, and Platform Firmware Resilience (PFR). In operation 1b, measurements are also collected for temporary bootstrap loaders like the TEE Module Loader or Secure Enhanced Authentication Module (SEAM). In operation 2a, a firmware certificate is generated, containing the measured values of the firmware components. In operation 2b, the execution thread is transferred from the hardware RoT to the firmware or Trusted Execution Environment (TEE) loader for further initialization. In operation 3a, the system collects measurements (evidence) of the TEE Manager. In operation 3b, measurements are collected from the quoting TEE component, which may be responsible for generating attestation reports. In operation 3c, additional service TEE components, such as the Migration TEE, are measured (i.e., evidence is collected). In operation 4, credentials are issued for the service and management layers, incorporating remote attestation evidence. In operation 5a, execution control is handed over to the TEE Manager, which may oversee the secure operation of the Trusted Execution Environment. In operation 5b, the TEE Manager loads the tenant TEE's initialization (bringup) module to prepare the environment for workload execution. In operation 6, measurements are taken (i.e., evidence is collected) of the Tenant TEE, also known as the bringup image, to ensure its authenticity and correctness. In operation 7, the measurements from the bringup phase are securely stored in a secure (e.g., tamper-resistant) location such as the TDX integrity register. In operation 8a, control is transferred to the Tenant TEE's bringup module. In operation 8b, the TEE runtime image is loaded into memory. In operation 9, integrity measurements are captured for the runtime image to confirm its integrity and compliance with security policies. In operation 10, the measurements of the runtime image are recorded in a secure data structure (e.g., an integrity register), like the TDX Runtime Measurement Register (RTMR). In operation 11, a secure communication channel, such as Transport Layer Security (TLS) or Secure Platform Management Dispatch Mechanism (SPDM), is established by loading its respective implementation image into the Tenant TEE. In operation 12, measurements are taken on the secure channel image. In operation 13, the secure channel measurements are stored in an integrity register, such as the TDX Runtime Measurement Register (RTMR), to maintain a verifiable record. In operation 14, the workload image, comprising the designated workload's executable code, is loaded. In operation 15, measurements (i.e., evidence) are collected of the workload image. In operation 16, the workload measurement is recorded in an integrity register like the TDX Runtime Measurement Register (RTMR). In operation 17, a remote attestation evidence token or certificate (e.g., a signed data structure and/or further data structure) is issued, containing the tenant TEE evidence.

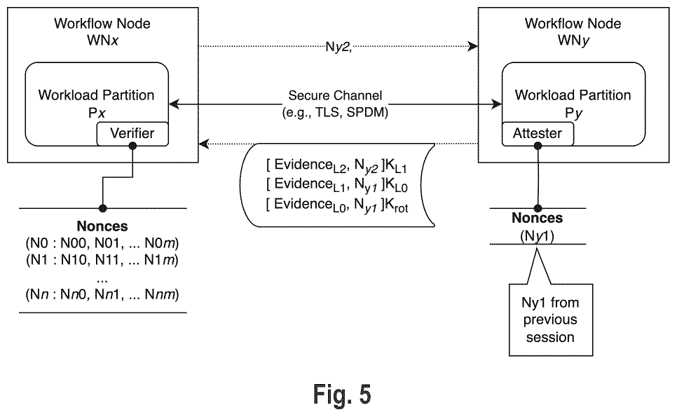

FIG. 5 shows an illustration of workflow nodes as attester and verifier with nonce exchange involving boot-time inclusion of nonce. FIG. 5 shows the two workflow nodes (WNx, Ny) connected via a secure channel (e.g., TLS, SPDM), where the first node (WNx) implements an attestation Verifier (verifier computer system), and the second node (WNy) implements an Attester as defined in RFC (Request for Comments) 9334 (e.g., an attester computer system). The Verifier wishes to receive fresh attestation evidence by supplying an attestation nonce, that, upon receipt, signals the Attester to collect attestation claims (e.g., measurements, evidence) for the various components used to construct the confidential computing environment.

The Verifier may be securely connected to other workflow nodes besides Ny. For each connected node, the Verifier may maintain a set of attestation evidence nonces (N0, N1, . . . , Ny, . . . . Nn). Each node may participate in the workflow for a variable amount of time where a peer node may reboot multiple times and where the secure channel may be established or re-established multiple times. The Verifier may supply two attestation evidence nonces when the first secure session is opened. The first nonce (Ny0) may be used for runtime evidence reporting and the second nonce (Ny1) may be stored in secure persistent memory where it may be included into boot-time issued evidence. If the Attester/peer (WNy) reboots and a new secure channel is negotiated, a third nonce (Ny2) may be supplied to the Attester (WNy). Ny2 may be stored in its secure persistent memory (Nonces) in case the node reboots a second time. This provisioning process may be repeated each time a secure connection is established between WNx and WNy.

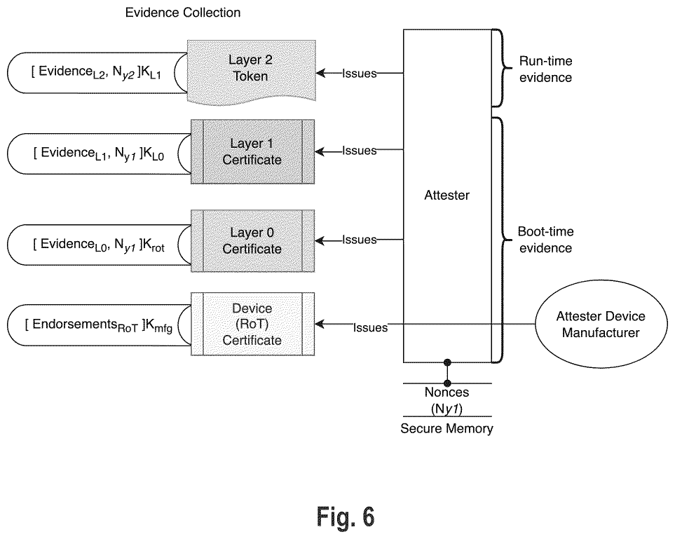

Each time the node (WNy) boots it may generate boot-time evidence as illustrated in FIG. 6. A collection of all the evidence blocks may be returned in response to an attestation request from the Verifier to the Attester. For each evidence block, a nonce may be included with the normal attestation evidence and signed by an appropriate attestation key. FIG. 5 shows three evidence blocks: Evidence_{L2}; which is dynamically issued and therefore contains the most recently supplied nonce (Ny2). These values may be digitally signed by the layer 1 attestation key (K_{L1}). Evidence_{L1} may be issued as part of the WNy reboot event which occurs before the secure channel can be established. The bootstrap attester may use Ny1 from the secure persistent storage which was obtained from/during the previous secure channel. Evidence_{L1} may be signed by an appropriate attestation key (K_{L0}). Evidence_{L0} may be issued as part of the WNy reboot event also where the RoT measures the Layer 0 environment and signs the evidence with the RoT key (K_{RoT}).

The verifier may validate the signatures over the evidence blocks and compare the nonce values with those for Ny in the Nonces secure memory. The verifier may ensure that the most recently supplied nonce is used with dynamically issued evidence and the most recently supplied nonce −1 is used for boot-time issued evidence. The verifier may rely on attestation key certificates, attestation endorsement information, or other trusted information to identify the components as either boot-time or run-time attestable components.

FIG. 6 shows an attester constructing evidence involving runtime and boot-time nonces supplied by a verifier. FIG. 6 shows an example Attester having four layered components of the attester, where three layers collect evidence at boot-time and one layer collects evidence at run-time. Evidence may be collected by a trusted component (a.k.a., Attesting Environment, AE) from its Target Environment (the next in the layering from bottom to top). The AE may wield attestation keys for signing evidence. The Root of Trust (RoT) attestation key may be provisioned at manufacturing time or upon first power up of the device. The device manufacturer may issue a certificate used to verify the key. Subsequent layers may have embedded certificate authority capabilities that issue a certificate containing the evidence or may sign evidence as a separate signed document a.k.a., token (see Entity Attestation Token (EAT), CBOR Web Token (CWT) or JSON Web Token (JWT)). When evidence is collected and then signed, there is an opportunity for the Attesting Environment to include an evidence freshness nonce. If the attester has proactively stored a nonce (Ny1) it can be included in a boot-time evidence block.

Various examples of the proposed concept may rely on a variety of secure persistent storage technologies such as Trusted Platform Module Non-Volatile memory (TPM NV), Dedicated Processor Engine Non-Volatile memory (DPE NV), or other write-protected memory block (WPMB) technology.

More details and aspects of the concept for a scalable distributed verifier with bootstrap nonce are mentioned in connection with the proposed concept or one or more examples described above or below (e.g., FIGS. 1a to 2b). The concept for a scalable distributed verifier with bootstrap nonce may comprise one or more additional optional features corresponding to one or more aspects of the proposed concept or one or more examples described above or below.

In the following, some examples of the proposed concept are presented:

An example (e.g., example 1) relates to a non-transitory computer-readable medium storing instructions that, when executed by one or more processing circuitries, cause the one or more processing circuitries to perform a method for an attester computer system, comprising collecting (110), during a boot process of the attester computer system, boot-time attestation evidence of the attester computer system, obtaining (120), during the boot process, a value being indicative of the boot process, with the value changing across boot processes, digitally signing (130), using an attestation key, at least one data structure comprising the boot-time attestation evidence and the value being indicative of the boot process, and providing (180) the at least one signed data structure to a verifier computer system.

Another example (e.g., example 2) relates to a previous example (e.g., example 1) or to any other example, further comprising that the value being indicative of the boot process comprises a verifier-specific nonce, with the method comprising obtaining the nonce from a secure persistent storage

Another example (e.g., example 3) relates to a previous example (e.g., example 2) or to any other example, further comprising that the method comprises obtaining (140), upon establishment of a secure communication channel between the attester computer system and the verifier computer system, a new verifier-specific nonce, and updating (150) the verifier-specific nonce in the secure persistent storage.

Another example (e.g., example 4) relates to a previous example (e.g., example 3) or to any other example, further comprising that the method comprises collecting (160), after obtaining the new verifier-specific nonce, run-time attestation evidence of the attester computer system, digitally signing (170) a further data structure comprising the run-time attestation evidence and the new verifier-specific nonce, and providing (180) the signed further data structure together with the at least one signed data structure to the verifier computer system.

Another example (e.g., example 5) relates to a previous example (e.g., example 4) or to any other example, further comprising that the at least one signed data structure comprises a verifier-specific nonce that was stored in the secure persistent storage prior to updating the verifier-specific nonce in the secure persistent storage and the signed further data structure comprises the new verifier-specific nonce.

Another example (e.g., example 6) relates to a previous example (e.g., one of the examples 2 to 5) or to any other example, further comprising that the method comprises storing (150) a plurality of verifier-specific nonces for a plurality of different verifier computer systems.

Another example (e.g., example 7) relates to a previous example (e.g., one of the examples 2 to 6) or to any other example, further comprising that the method comprises, if the collected boot-time evidence differs from prior collected boot-time evidence, deleting (115) one or more stored nonces, and signing the at least one data structure without including a nonce in the data structure.

Another example (e.g., example 8) relates to a previous example (e.g., one of the examples 1 to 7) or to any other example, further comprising that the value being indicative of the boot process comprises a value being indicative of a boot time.

Another example (e.g., example 9) relates to a previous example (e.g., example 8) or to any other example, further comprising that the value being indicative of a boot time expresses the boot time relative to an epoch.

Another example (e.g., example 10) relates to a previous example (e.g., one of the examples 1 to 9) or to any other example, further comprising that the value being indicative of the boot process comprises a number that increases monotonically across boot processes.

Another example (e.g., example 11) relates to a previous example (e.g., one of the examples 1 to 10) or to any other example, further comprising that the value being indicative of the boot process indicates a freshness of the boot-time attestation evidence.

Another example (e.g., example 12) relates to a previous example (e.g., one of the examples 1 to 11) or to any other example, further comprising that at least the acts of obtaining the value being indicative of the boot process and digitally signing the at least one data structure are performed by firmware or root of trust of the attester computer system.

Another example (e.g., example 13) relates to a previous example (e.g., one of the examples 1 to 11) or to any other example, further comprising that the at least one signed data structure is provided to a verifier computer system that follows the attester computer system in a sequence defined by a workflow.

An example (e.g., example 14) relates to a method for an attester computer system, comprising collecting (110), during a boot process of the attester computer system, boot-time attestation evidence of the attester computer system, obtaining (120), during the boot process, a value being indicative of the boot process, with the value changing across boot processes, digitally signing (130), using an attestation key, at least one data structure comprising the boot-time attestation evidence and the value being indicative of the boot process, and providing (180) the at least one signed data structure to a verifier computer system.

Another example (e.g., example 15) relates to a computer program having a program code for performing the method of example 14, when the computer program is executed on a computer, a processor, or a programmable hardware component.

An example (e.g., example 16) relates to an apparatus (10) for an attester computer system, the apparatus comprising interface circuitry (12), machine-readable instructions, and processor circuitry (14) to execute the machine-readable instructions to collect (110), during a boot process of the attester computer system, boot-time attestation evidence of the attester computer system, obtain (120), during the boot process, a value being indicative of the boot process, with the value changing across boot processes, digitally sign (130), using an attestation key, at least one data structure comprising the boot-time attestation evidence and the value being indicative of the boot process, and provide (180) the at least one signed data structure to a verifier computer system.

An example (e.g., example 17) relates to a device (10) for an attester computer system, the device comprising means for communicating (12), machine-readable instructions, and means for processing (14) for executing the machine-readable instructions to collect (110), during a boot process of the attester computer system, boot-time attestation evidence of the attester computer system, obtain (120), during the boot process, a value being indicative of the boot process, with the value changing across boot processes, digitally sign (130), using an attestation key, at least one data structure comprising the boot-time attestation evidence and the value being indicative of the boot process, and provide (180) the at least one signed data structure to a verifier computer system.

Another example (e.g., example 18) relates to an attester computer system (100) comprising the apparatus (10) according to example 16 or the device (10) according to example 17.

An example (e.g., example 19) relates to a non-transitory computer-readable medium storing instructions that, when executed by one or more processing circuitries, cause the one or more processing circuitries to perform a method for a verifier computer system, comprising obtaining (220), from an attester computer system, a signed data structure comprising boot-time attestation evidence and a value being indicative of a boot process, verifying (230) a signature of the data structure and the boot-time attestation evidence, determining (240) a freshness of the boot-time attestation evidence based on the value being indicative of the boot process, and determining (280) an integrity of the attester based on the verification of the signature of the data structure and the boot-time attestation evidence and based on the freshness of the boot-time attestation evidence.

Another example (e.g., example 20) relates to a previous example (e.g., example 19) or to any other example, further comprising that the value being indicative of the boot process comprises a verifier-specific nonce.

Another example (e.g., example 21) relates to a previous example (e.g., example 20) or to any other example, further comprising that the method comprises providing (210), prior to obtaining the signed data structure from the attester computer system, the verifier-specific nonce to the attester computer system.

Another example (e.g., example 22) relates to a previous example (e.g., example 21) or to any other example, further comprising that the verifier-specific nonce is provided to the attester computer system upon establishment of a secure communication channel between the verifier computer system and the attester computer system.

Another example (e.g., example 23) relates to a previous example (e.g., one of the examples 20 to 22) or to any other example, further comprising that determining the freshness of the boot-time attestation evidence comprises comparing the verifier-specific nonce to one or more verifier-specific nonces that have previously been provided to the attester computer system.

Another example (e.g., example 24) relates to a previous example (e.g., example 23) or to any other example, further comprising that the method comprises obtaining (250) a further data structure comprising run-time attestation evidence and a further verifier-specific nonce from the attester computer system, and comparing the further verifier-specific nonce to a most recent verifier-specific nonce that has previously been provided to the attester computer system to determine (260) a freshness of the run-time attestation evidence.

Another example (e.g., example 25) relates to a previous example (e.g., one of the examples 19 to 24) or to any other example, further comprising that the value being indicative of the boot process comprises a value being indicative of a boot time, with determining the freshness of the boot-time attestation evidence comprising comparing the boot time to a current time or to a reference time.

Another example (e.g., example 26) relates to a previous example (e.g., one of the examples 19 to 25) or to any other example, further comprising that the value being indicative of the boot process comprises a number that increases monotonically across boot processes, with determining the freshness of the boot-time attestation evidence comprising comparing the number that increases monotonically across boot processes to one or more previously obtained numbers associated with the attester computer system.

Another example (e.g., example 27) relates to a previous example (e.g., one of the examples 19 to 26) or to any other example, further comprising that the at least one signed data structure is obtained from an attester computer system that precedes the verifier computer system in a sequence defined by a workflow.

An example (e.g., example 28) relates to a method for a verifier computer system, comprising obtaining (220), from an attester computer system, a signed data structure comprising boot-time attestation evidence and a value being indicative of a boot process, verifying (230) a signature of the data structure and the boot-time attestation evidence, determining (240) a freshness of the boot-time attestation evidence based on the value being indicative of the boot process, and determining (270) an integrity of the attester based on the verification of the signature of the data structure and the boot-time attestation evidence and based on the freshness of the boot-time attestation evidence.

Another example (e.g., example 29) relates to a computer program having a program code for performing the method of example 28, when the computer program is executed on a computer, a processor, or a programmable hardware component.

An example (e.g., example 30) relates to an apparatus for a verifier computer system, comprising interface circuitry, machine-readable instructions, and processor circuitry to execute the machine-readable instructions to obtain, from an attester computer system, a signed data structure comprising boot-time attestation evidence and a value being indicative of a boot process, verify a signature of the data structure and the boot-time attestation evidence, determine a freshness of the boot-time attestation evidence based on the value being indicative of the boot process, and determine an integrity of the attester based on the verification of the signature of the data structure and the boot-time attestation evidence and based on the freshness of the boot-time attestation evidence.

An example (e.g., example 31) relates to a device (20) for a verifier computer system, the device comprising means for communicating (22), machine-readable instructions, and means for processing (24) for executing the machine-readable instructions to obtain, from an attester computer system, a signed data structure comprising boot-time attestation evidence and a value being indicative of a boot process, verify a signature of the data structure and the boot-time attestation evidence, determine a freshness of the boot-time attestation evidence based on the value being indicative of the boot process, and determine an integrity of the attester based on the verification of the signature of the data structure and the boot-time attestation evidence and based on the freshness of the boot-time attestation evidence.

Another example (e.g., example 32) relates to a verifier computer system (200) comprising the apparatus (20) according to example 30 or the device (20) according to example 31.

Another example (e.g., example 33) relates to the verifier computer system according to example 32, further comprising the apparatus (10) according to example 16 or the device (10) according to example 17.

Another example (e.g., example 34) relates to a system comprising the verifier computer system (200) according to one of the examples 32 or 32 and the attester computer system (100) according to example 18.

Another example (e.g., example 35) relates to a system comprising two or more computer systems according to example 33.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions.

Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by one or more processing circuitries, cause the one or more processing circuitries to perform a method for an attester computer system, comprising:
collecting, during a boot process of the attester computer system, boot-time attestation evidence of the attester computer system;
obtaining, during the boot process, a value being indicative of the boot process, with the value changing across boot processes;
digitally signing, using an attestation key, at least one data structure comprising the boot-time attestation evidence and the value being indicative of the boot process; and
providing the at least one signed data structure to a verifier computer system.

2. The non-transitory computer-readable medium according to claim 1, wherein the value being indicative of the boot process comprises a verifier-specific nonce, with the method comprising obtaining the nonce from a secure persistent storage.

3. The non-transitory computer-readable medium according to claim 2, wherein the method comprises obtaining, upon establishment of a secure communication channel between the attester computer system and the verifier computer system, a new verifier-specific nonce, and updating the verifier-specific nonce in the secure persistent storage.

4. The non-transitory computer-readable medium according to claim 3, wherein the method comprises collecting, after obtaining the new verifier-specific nonce, run-time attestation evidence of the attester computer system, digitally signing a further data structure comprising the run-time attestation evidence and the new verifier-specific nonce, and providing the signed further data structure together with the at least one signed data structure to the verifier computer system.

5. The non-transitory computer-readable medium according to claim 4, wherein the at least one signed data structure comprises a verifier-specific nonce that was stored in the secure persistent storage prior to updating the verifier-specific nonce in the secure persistent storage and the signed further data structure comprises the new verifier-specific nonce.

6. The non-transitory computer-readable medium according to claim 2, wherein the method comprises storing a plurality of verifier-specific nonces for a plurality of different verifier computer systems.

7. The non-transitory computer-readable medium according to claim 2, wherein the method comprises, if the collected boot-time evidence differs from prior collected boot-time evidence, deleting one or more stored nonces, and signing the at least one data structure without including a nonce in the data structure.

8. The non-transitory computer-readable medium according to claim 1, wherein the value being indicative of the boot process comprises a value being indicative of a boot time.

9. The non-transitory computer-readable medium according to claim 8, wherein the value being indicative of a boot time expresses the boot time relative to an epoch.

10. The non-transitory computer-readable medium according to claim 1, wherein the value being indicative of the boot process comprises a number that increases monotonically across boot processes.

11. The non-transitory computer-readable medium according to claim 1, wherein the value being indicative of the boot process indicates a freshness of the boot-time attestation evidence.

12. The non-transitory computer-readable medium according to claim 1, wherein at least the acts of obtaining the value being indicative of the boot process and digitally signing the at least one data structure are performed by firmware or root of trust of the attester computer system.

13. The non-transitory computer-readable medium according to claim 1, wherein the at least one signed data structure is provided to a verifier computer system that follows the attester computer system in a sequence defined by a workflow.

14. An apparatus for an attester computer system, the apparatus comprising interface circuitry, machine-readable instructions, and processor circuitry to execute the machine-readable instructions to:
collect, during a boot process of the attester computer system, boot-time attestation evidence of the attester computer system;
obtain, during the boot process, a value being indicative of the boot process, with the value changing across boot processes;
digitally sign, using an attestation key, at least one data structure comprising the boot-time attestation evidence and the value being indicative of the boot process; and
provide the at least one signed data structure to a verifier computer system.

15. A non-transitory computer-readable medium storing instructions that, when executed by one or more processing circuitries, cause the one or more processing circuitries to perform a method for a verifier computer system, comprising:
obtaining, from an attester computer system, a signed data structure comprising boot-time attestation evidence and a value being indicative of a boot process;
verifying a signature of the data structure and the boot-time attestation evidence;
determining a freshness of the boot-time attestation evidence based on the value being indicative of the boot process; and
determining an integrity of the attester based on the verification of the signature of the data structure and the boot-time attestation evidence and based on the freshness of the boot-time attestation evidence.

16. The non-transitory computer-readable medium according to claim 15, wherein the value being indicative of the boot process comprises a verifier-specific nonce.

17. The non-transitory computer-readable medium according to claim 16, wherein the method comprises providing, prior to obtaining the signed data structure from the attester computer system, the verifier-specific nonce to the attester computer system.

18. The non-transitory computer-readable medium according to claim 17, wherein the verifier-specific nonce is provided to the attester computer system upon establishment of a secure communication channel between the verifier computer system and the attester computer system.

19. The non-transitory computer-readable medium according to claim 16, wherein determining the freshness of the boot-time attestation evidence comprises comparing the verifier-specific nonce to one or more verifier-specific nonces that have previously been provided to the attester computer system.

20. The non-transitory computer-readable medium according to claim 19, wherein the method comprises obtaining a further data structure comprising run-time attestation evidence and a further verifier-specific nonce from the attester computer system, and comparing the further verifier-specific nonce to a most recent verifier-specific nonce that has previously been provided to the attester computer system to determine a freshness of the run-time attestation evidence.
